(19) United States
(12) Patent Application Publication
(10) Pub. No.: US 2026/0258202 A1
(43) Pub. Date: Sep. 3, 2026

(54) IONOMERIC POLYMERS USEFUL AS MEMBRANES AND BINDERS

(71) Applicants: UCHICAGO ARGONNE, LLC, Argonne, IL (US); THE UNIVERSITY OF CHICAGO, Chicago, IL (US)

(72) Inventors: Christopher G. ARGES, Naperville, IL (US); Paul F. NEALEY, Chicago, IL (US); Mincheol KIM, Chicago, IL (US); Chuan Pin CHEN, Willow Springs, IL (US)

(73) Assignees: UCHICAGO ARGONNE, LLC, Argonne, IL (US); THE UNIVERSITY OF CHICAGO, Chicago, IL (US)

(21) Appl. No.: 19/552,204

(22) Filed: Feb. 27, 2026

Related U.S. Application Data
(60) Provisional application No. 63/765,493, filed on Feb. 28, 2025.

(51) Int. Cl. C08G 79/04; H01M 4/86; H01M 8/1034; H01M 8/1058; H01M 8/1065

(52) U.S. Cl. CPC C08G 79/04; H01M 4/8668; H01M 8/1034; H01M 8/1058; H01M 8/1065; H01M 2300/0082

(57) ABSTRACT

Described herein are fluorene-free or low-fluorine content ionomeric polymers with a hydrocarbon backbone and pendant phosphonic acid and sulfonic acid/sulfonimide groups. The polymers are useful as, e.g., high temperature polymer electrolyte membranes (HT-PEMs) for fuel cells, which do not require imbibed liquid acid in the membrane, as electrode binders (e.g., for fuel cell electrodes; as components of supercapacitors, and as membranes for waste heat recovery systems, and as membranes for hydrogen pumps for hydrogen separation. The HT-PEMs described herein can operate under hot (130 to 220° C.), dry conditions.

### CROSS-REFERENCE TO RELATED APPLICATIONS

This application claims the benefit of U.S. Provisional Application Ser. No. 63/765,493, filed on Feb. 28, 2025, which is incorporated herein by reference in its entirety.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to ionomeric polymers. More particularly, this invention relates to ionomeric polymers bearing pendant phosphonate groups in combination with sulfonate and/or sulfonimide-type groups.

### BACKGROUND

Polymer electrolyte fuel cells, also known as proton exchange fuel cells, use a proton-conducting polymer membranes as the electrolyte and hydrogen gas as the fuel. Polymer electrolyte membranes (PEMs) are used as the electrolyte in fuel cells. The PEMs selectively allow protons to pass through the membrane. The PEMs also keep the anode and cathode compartments separated, while allowing proton (hydrogen ion) conduction to generate electrical current. PEM) fuel cells are commonly used in applications like electric vehicles and stationary power.

Ionomeric polymers are useful for a variety of application including ion exchange membranes, ion-exchange resins, polymeric electrolyte membranes for fuel cells, and binders for preparing electrodes for fuel cells. Polymer electrolyte membranes that are stable across a wide temperature range (e.g., 0 to about 220° C.), referred to herein as HT-PEM materials or HT-PEMs are useful as combination electrolyte and separator membranes for fuel cells.

The most mature HT-PEM materials are based upon phosphoric acid (H₃PO₄) imbibed poly(benzimidazole) (PBI). The commercial gel p-PBI20 with H₃PO₄ operates under a relatively narrow temperature range because high temperatures (>100° C.) lead to H₃PO₄ evaporation, while temperatures below 100° C. cause H₃PO₄ leaching due to water intrusion that supplants the H₃PO₄ from the polymer matrix. Ion-pair HT-PEMs, which feature cations (e.g., quaternary ammonium cations) tethered to the backbone, anchor phosphate anions stabilizing the H₃PO₄ cluster, leading to more robust stability over a wider temperature range while also showing high ionic conductivity due to greater hydrogen bonding frustration. Although ion-pair HT-PEM fuel cells have achieved remarkable performance and stability, they still suffer from H₃PO₄ redistribution into the electrode layers (albeit much lower when compared to PBI). The presence of liquid H₃PO₄ in electrode layers compromises fuel cell performance and makes it difficult to realize an HT-PEM fuel cell with low PGM loadings.

There is an ongoing need for new polymeric materials that are useful for HT-PEM applications that can operate effectively without imbibed phosphoric acid and as binders for fuel cell electrodes. The polymers described herein address this need.

### SUMMARY

Described herein are fluorine-free and low-fluorine hydrocarbon polymers. The polymers described herein are variously useful as high-temperature polymer electrolyte membranes (HT-PEMs) for fuel cells and/or as binders for fuel cell electrodes. When formed into HT-PEM materials, the resulting membranes operate effectively without imbibed phosphoric acid. The described polymers comprise a hydrocarbon backbone that is either fluorine-free or that has a low fluorine content, e.g., no more than three fluorine groups per monomer unit of the polymer (e.g., comprising one —CF₃ group), and include pendant acidic phosphorous- and sulfur-containing moieties to facilitate proton exchange. In particular, the polymers include pendant phosphonic acid groups (—PO₃H₂) and pendant acidic sulfur-containing groups selected from sulfonic acid groups (—SO₃H) and sulfonimide groups pf formula —SO₂NHSO₂Z, in which Z is a hydrocarbon group (e.g., alkyl, aryl, and the like) or a phosphonic acid group (—PO₃H₂). As noted above, PEMs that require imbibed liquid acids are prone to leaching of the acids, resulting in compromised electrode activity, greater reactant mass transfer resistances, and increased membrane ohmic resistances when used in conventional fuels cells. The polymers described herein do not require imbibed acids when used as HT-PEMs, avoiding the undesirable consequences caused by the liquid acids.

In some embodiments, the polymer comprises hydrocarbon monomer units bearing phosphonic acid groups and hydrocarbon monomer units beating sulfur-containing acidic groups of formula —SO₂NHSO₂Z, in which Z is a hydrocarbon group (e.g., alkyl, aryl, and the like) or a phosphonic acid group. The hydrocarbon monomer units are either fluorine-free or comprise no more than three fluorine atoms per monomer unit. The copolymer preferably is soluble in an organic solvent having a boiling point of less than about 170° C., e.g., a boiling point of about 80 to 160° C. In some embodiments, the polymer is soluble in a C₁ to C₆ alcohol.

In some embodiments, a polymer described herein comprises hydrocarbon backbone formed from at least two different monomer units, one bearing a phosphonic acid group, and at least one other, different monomer units bearing pendent sulfur-containing acidic group selected from sulfonic acid groups, and/or sulfonimide groups. In some embodiments the polymer is a copolymer of Formula (I):

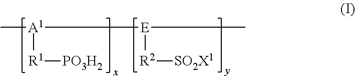

wherein A and E are hydrocarbon backbone groups, which can be the same or different; A-R¹—PO₃H₂ is a first repeating monomer unit; E-R²—SO₂X¹ is a second repeating monomer unit; R¹ and R² independently are covalent bonds or comprise hydrocarbyl groups (e.g., alkyl, aryl or other hydrocarbon groups); X¹ is selected from the group consisting of OH and NHSO₂Z¹; Z¹ is selected from the group consisting of hydrocarbyl (e.g., alkyl, aryl or another hydrocarbon moiety) and —PO₃H₂; and x and y are the number of repeats of the first and second monomer units, respectively. Both x and y are greater than 0, and the sum of x and y typically is selected to be sufficient to provide a polymer with a weight average molecular weight (Mw) of greater than about 50,000 g/mol in the case of poly(norbornene) polymers, and with a number average molecular weight (Mn) of greater than about 40,000 g/mol in the case of poly(phenylene alkylene) polymers. Optionally, the hydrocarbyl groups comprise (a) one or more halogen, oxygen-, nitrogen-, and/or sulfur-containing substituent; (b) one or more substitution of oxygen, nitrogen, and/or sulfur replacing a carbon of the hydrocarbyl group; or (c) both (a) and (b), The polymer backbone components A and E are fluorine-free or have a relatively low fluorine content of no more than three fluorine groups per monomer unit. Non-limiting examples of suitable polymer backbones (i.e., the combination of A and E) include poly(phenylene alkylene), poly(norbornene), and polymers with intrinsic microporosity (PIM) (e.g., the polymer known as PIM-1).

In HT-PEMs formed from the polymers described herein, the combination of phosphonic acid groups and acidic sulfur-containing groups decorating the polymer backbone provides efficient proton transfer across the membrane without the need for imbibed liquid acids (e.g., imbibed phosphoric acid). When used as binders for fuel cell electrodes, and the like, the combination of phosphonic acid groups and acidic sulfur-containing groups decorating the polymer backbone also facilitate proton flow through the electrode composition.

The polymers described herein can also be used as PEMs in electrodialysis, electrodeionization, membrane capacitive deionization, water electrolyzers, carbon dioxide electrolyzers, fuel cells, electrochemical hydrogen pumps, supercapacitors, and for electrochemical waste heat recovery systems.

The polymers described herein can optionally comprise one or more other hydrocarbon monomer units in addition to A-R¹—PO₃H₂ and E-R²—SO₂X, if desired. In addition, the polymers can be random copolymers, block copolymers, linear polymers, branched polymers, and/or crosslinked polymers.

The following non-limiting embodiments are provided to illustrate certain aspects and features of the materials described herein.

Embodiment 1 is a polymer of Formula (I):

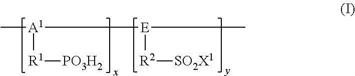

wherein A-R¹—PO₃H₂ is a first repeating monomer unit;
E-R²—SO₂X¹ is a second repeating monomer unit;
A and E each independently comprises a first hydrocarbyl group;
R¹ and R² each independently is a covalent bond or comprises a second hydrocarbyl group;
X¹ is selected from the group consisting of OH and NHSO₂Z¹;
Z¹ is selected from the group consisting of a third hydrocarbyl group and —PO₃H₂;
x and y are the number of repeats of the first and second monomer units, respectively; and
both x and y are greater than 0;
wherein one or more of the first, second, and third hydrocarbyl groups optionally comprises (a) one or more halogen, oxygen-, nitrogen-, and/or sulfur-containing substituent; (b) one or more substitution of oxygen, nitrogen, and/or sulfur replacing a carbon of the hydrocarbyl group; or (c) both (a) and (b); and the polymer is fluorine-free or comprises no more than three fluorine substituents per monomer unit.

Embodiment 2 is the polymer of embodiment 1, wherein the first hydrocarbyl group comprises a moiety selected from the group consisting of linear alkyl, branched alkyl, cycloalkyl, linear alkenyl, branched alkenyl, cycloalkenyl, aryl, and a combination of two or more of the foregoing.

Embodiment 3 is the polymer of embodiment 1 or embodiment 2, wherein the second hydrocarbyl group comprises a moiety selected from the group consisting of linear alkyl, branched alkyl, cycloalkyl, linear alkenyl, branched alkenyl, cycloalkenyl, aryl, and a combination of two or more of the foregoing.

Embodiment 4 is the polymer of any one of embodiments 1 to 3, wherein the third hydrocarbyl group comprises a moiety selected from the group consisting of alkyl, aryl, and a combination thereof.

Embodiment 5 is the polymer of any one of embodiments 1 to 4, wherein X¹ is OH.

Embodiment 6 is the polymer of any one of embodiments 1 to 5, wherein X¹ is NHSO₂Z¹.

Embodiment 7 is the polymer of embodiment 6, wherein Z¹ is the third hydrocarbyl group.

Embodiment 8 is the polymer of any one of embodiments 1 to 7, wherein Z¹ is —PO₃H₂.

Embodiment 9 is the polymer of any one of embodiments 1 to 8, wherein the sum of x+y is at least about 25.

Embodiment 10 is the polymer of any one of embodiments 1 to 9, wherein the sum of x+y is about 25 to about 500.

Embodiment 11 is the polymer of any one of embodiments 1 to 10, wherein the ratio of x:y is at least about 0.1:1.0 to about 1.0:0.1.

Embodiment 12 is the polymer of any one of embodiments 1 to 11, wherein A and E together constitute a polymer backbone selected from the group consisting of a poly(arylene alkylene), a poly(norbornene), a polymer of intrinsic porosity, a cyclic polyolefin, a polyolefin, a polyimide, and a poly(arylene ether).

Embodiment 14 is the polymer of any one of embodiments 1 to 12, wherein the polymer is soluble in an organic solvent having a boiling point of less than about 170° C.

Embodiment 15 is the polymer of embodiment 14, wherein the solvent is a C₁ to C₆ alcohol.

Embodiment 16 is a polymer electrolyte membrane comprising the polymer of any one of embodiments 1 to 15 in the form of a free-standing membrane having a thickness of about 10 μm to about 100 μm, or on and imbibed in a porous support structure.

### BRIEF DESCRIPTION OF THE DRAWINGS

FIG. 1 provides synthesis schemes for making fluorine-free/low-fluorine polymers with bromo groups: (a) poly(phenylene alkylene), (b) ROMP poly(norbornene), and (c) PIM-1; and (d) provides a generalized synthesis scheme to introduce phosphonic acid and sulfonic acid/sulfonimide in place of the bromo groups.

FIG. 2 schematically illustrates the operational principles of an electrochemical hydrogen pump using a HT-PEM.

FIG. 3 provides alternative synthesis schemes for preparing the polymers described herein.

### DETAILED DESCRIPTION

Described herein are fluorine-free or low-fluorine content ionomeric polymers with a hydrocarbon backbone and pendant phosphonic acid and sulfonic acid/sulfonimide groups. The polymers are useful as, e.g., high temperature polymer electrolyte membranes (HT-PEMs) for fuel cells, which do not require imbibed liquid acid in the membrane, as electrode binders (e.g., for fuel cell electrodes; as components of supercapacitors, and as membranes for waste heat recovery systems, and as membranes for electrochemical hydrogen pumps for hydrogen separation). The HT-PEMs described herein can operate under hot (up to 250° C.), dry conditions. In some embodiments, the fluorine-free and low-fluorine polymers are polymers of Formula (I), as described herein.

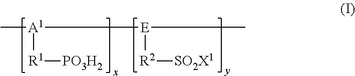

wherein A-R¹—PO₃H₂ is a first repeating monomer unit; E-R²—SO₂X¹ is a second repeating monomer unit; A and E each independently comprises a first hydrocarbyl group; R¹ and R² each independently is a covalent bond or comprises a second hydrocarbyl group; X¹ is selected from the group consisting of OH and NHSO₂Z¹; Z¹ is selected from the group consisting of a third hydrocarbyl group and —PO₃H₂; x and y are the number of repeats of the first and second monomer units, respectively; and both x and y are greater than 0; wherein one or more of the first, second, and third hydrocarbyl groups optionally comprises (a) one or more halogen, oxygen-, nitrogen-, and/or sulfur-containing substituent; (b) one or more substitution of oxygen, nitrogen, and/or sulfur replacing a carbon of the hydrocarbyl group; or (c) both (a) and (b); and the polymer is fluorine-free or comprises no more than three fluorine substituents per monomer unit.

In some embodiments, the polymers are polymers of Formula (I), as described above, such as polymers of Formulas (II), (III), (IV), (V), and (VI) described below.

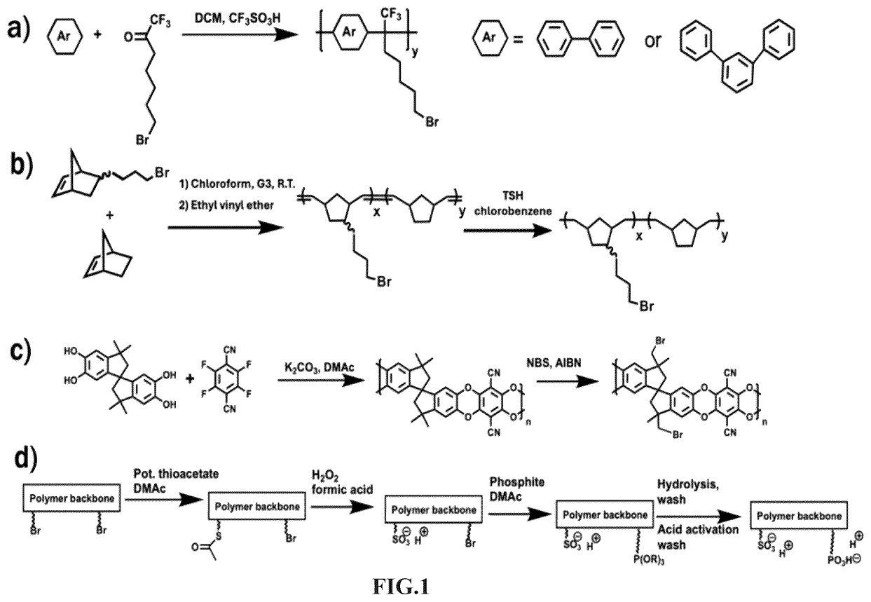

FIG. 1 illustrates synthetic schemes for preparing selected polymers of Formula (I). In particular, poly(bi-/ter-phenylene alkylene) with terminal bromo groups using the well-established super acid-catalyzed polyhydroxyalkylation (FIG. 1, panel a). Ring-opening metathesis polymerization (ROMP) with a Grubbs generation 3 (G₃) catalyst provides poly(norbornene) with pendant alkyl substituents featuring terminal bromo groups (FIG. 1, panel b). The olefin groups in the polymer backbone are hydrogenated using p-toluenesulfonyl hydrazide (TSH) under reflux to shore up the polymers' mechanical properties. PIMs (e.g., PIM-1) are prepared as described in the literature (FIG. 1, panel c). PIMs are useful as electrode binders. These polymers have a ‘kink-like” structure in the backbone that creates large free volume values, which is important for enhancing gas reactant transport.

The introduction of ionic moieties into the polymer backbones (FIG. 1, panel d) is performed by converting some of the bromo groups to thiol acetate via nucleophilic addition. The thiol acetate can undergo heterogenous oxidation with hydrogen peroxide and formic acid to make a sulfonic acid. Then, the remainder of the bromo groups are converted to phosphites via nucleophilic substitution followed by hydrolysis in boiling deionized water (or diluted acid) to convert the phosphite to phosphonic acid. Then, the polymer solid is washed and drop cast into free-standing membranes or processed into reinforced porous supports, followed by acid activation and washing for membrane characterization. Alternatively, the sulfonic acid groups can be converted into sulfonimide groups, which dissociate more readily under dry conditions, by converting sulfonic acid into sulfonyl chloride followed by reacting the sulfonyl chlorides with R-sulfonamide (R being -methyl, -ethyl, etc.).

An alternative to using copolymers containing phosphonic acid and sulfonic acid/sulfonimide and sulfonimide with terminal phosphonic acid moieties, blends of ionomer materials can be used. For example, one embodiment of the blend is a polymer only featuring sulfonic acid and/or sulfonimide pendant groups mixed with another polymer having pendant phosphonic acid groups and/or sulfonimide groups comprising a terminal phosphonic acid.

The molecular weight values and polydispersity indices of the synthesized polymers with the bromo-group can be determined using gel-permeation chromatography (GPC). The IEC of the prepared membranes is determined using acid-base titration. Nuclear magnetic resonance (NMR) is used to determine the chemical structure of the polymers. The extent of phosphonic acid groups will be determined using ³¹P NMR (using an internal standard for qualifying the amount of phosphonic acid groups).

The properties of the free-standing membranes and thin films can be assessed using in-plane and through-plane proton conductivity using 4-point (in-plane) and 2-point (through-plane) methods. Interdigitated electrode arrays (IDAs) can be used to measure thin film ionomer conductivity. All conductivity measurements can be performed from room temperature to 220° C. in environmental chambers with nitrogen. The through-plane conductivity values is used to determine the ASR of the HT-PEMs.

The α-transition temperature (Tα) of the membranes can be determined using a dynamical mechanical analyzer (DMA). This method applies an oscillatory force while recording the storage and loss moduli during a temperature sweep. The tan δ is determined from the ratio of the loss modulus to the storage modulus. The Ta is identified at the temperature where the maximum tan δ is attained. The Ta can be related to thermal stability as well as ion and gas transport properties. Finally, the HT-PEMs can be evaluated for H₂ crossover in a fuel cell by measuring the crossover current density.

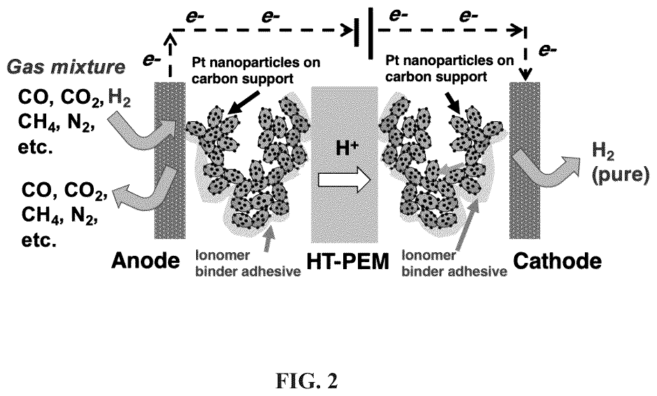

FIG. 2 schematically illustrates an electrochemical hydrogen pump comprising an anode, a cathode, and an HT-PEM as described herein between the anode and the cathode. The anode and cathode active materials comprise platinum nanoparticles on a carbon support with ionomeric binders to hold the active materials together and facilitate proton transport. A gas mixture comprising methane and other gases (CO, CO₂, N₂, etc.) is contacted with the anode, and hydrogen is oxidized at the anode producing protons from the hydrogen in the hydrogen natural gas mixture. The protons cross from the anode through the HT-PEM to the cathode, where the protons are reduced to hydrogen gas.

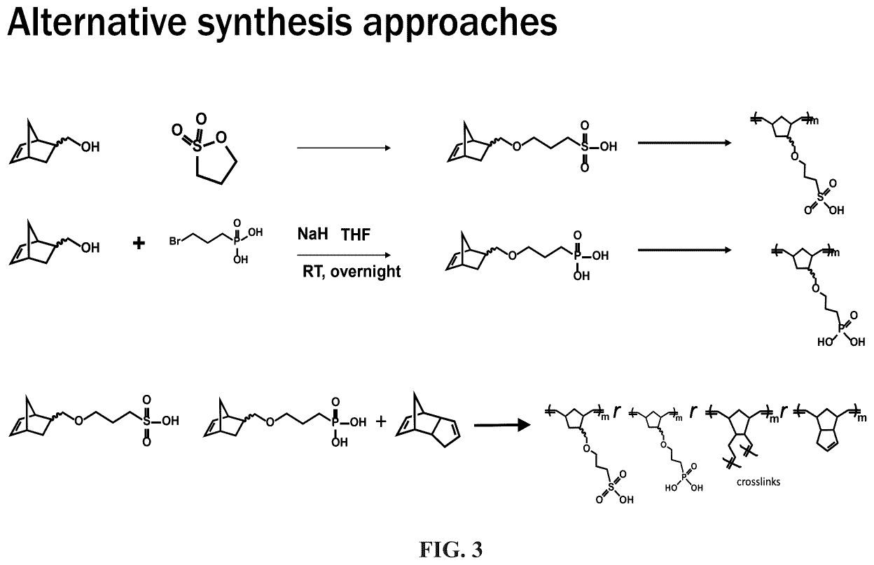

FIG. 3 provides alternative synthesis routes for preparing the polymers described herein. The alternative synthetic approach in FIG. 3 involves introducing a sulfonic acid group onto a hydroxy-substituted monomer (illustrated by a hydroxymethyl-substituted norbornene) by reaction of 1,3-propane sultone with the hydroxy-substituted monomer using a strong base (e.g., NaH) in a suitable solvent (e.g., THF). A phosphonic acid group is introduced onto a hydroxy-substituted monomer in a similar fashion by reaction with 3-bromopropyl phosphonic acid using a strong base (e.g., NaH) in a suitable solvent (e.g., THF). The resulting monomers can be copolymerized (e.g., by ring-opening polymerization using G₃ catalyst; i.e., [1,3-bis(2,4,6-trimethylphenyl)-2-imidazolidinylidene]dichloro(benzylidene) bis(3-bromopyridine)ruthenium(II), as illustrated for the norbornene monomers. Optionally, the polymers can include a third monomer, as illustrated in the bottom scheme of FIG. 3.

In some embodiments, the polymers are poly(arylene alkylene) copolymers in which the arylene groups typically include biphenylene and terphenylene groups.

In some other embodiments, the polymers are poly(norbornene) copolymers, such as ring-opening polymerization poly(norbornene) (ROMP-PNB) copolymers, hydrogenated ROMP-PNB copolymers (i.e., ROMP-PNB copolymers in which the backbone vinyl groups have been saturated), vinyl addition poly(norbornene) (VA-PN) copolymers.

In yet other embodiments, the polymers are polymers of intrinsic porosity (PIM), such as derivatives of PIM-1 bearing pendant phosphonic acid and sulfonic acid/sulfonimide groups.

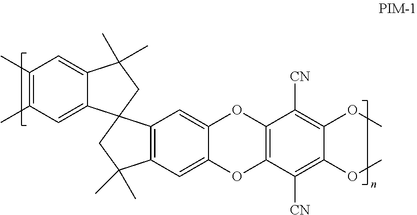

The polymers described herein can optionally comprise one or more other hydrocarbon monomer units in addition to A-R¹—PO₃H₂ and E-R²—SO₂X¹, if desired. In addition, the polymers can be random copolymers, block copolymers, linear polymers, branched polymers, and/or crosslinked polymers.

Ionomers for electrode binders are solution processable in low-boiling point, alcohol-based solvents, making them useful for preparing gas diffusion electrodes (GDEs) or catalyzed coated membranes (CCMs). The ion-exchange capacity (IEC) values of the tethered anion groups, as well as the ratio of phosphonic acid to sulfonic acid/sulfonimide in the copolymers, can be selected to maximize proton conductivity.

Table 1 provides some exemplary performance metrics for HT-PEMs formed from the ionomeric copolymers described herein.

TABLE 1
Exemplary Ionomeric Polymer Performance Parameters Assuming 50 μm Thick PEM.

| | Metric | Preferred | | More Preferred | | Typical | |
|---|---|---|---|---|---|---|---|
| Ionomer | IEC | ≥1.5 | mequiv g⁻¹ | ≥2.0 | mequiv g⁻¹ | ≥1.2 | mequiv g⁻¹ |
| HT-PEM | ASR at 220° C.; | ≤0.05 | Ω-cm² | ≤0.02 | Ω-cm² | ≤0.125 | Ω-cm² |
| properties | H₂ crossover at 180° C. | ≤3 | mA cm⁻² | ≤1.5 | mA cm⁻² | ≤2.2 | mA cm⁻² |
| HT-PEM fuel | Cell voltage at 1.07 A cm⁻² | ≥0.60 | V | ≥0.70 | V | ≥0.50 | V |
| cell performance | w/<0.6 mgPGM cm⁻² | | | | | | |
| HT-PEM | Time to membrane failure | ≥650 | hours | ≥800 | hours | ≥580 | hours |

| | |
|---|---|
| durability | during OCV hold |

ASR = area specific resistance;
IEC = ion exchange capacity;
OCV = open circuit voltage;
PGM = platinum group metal fuel cell catalyst

The new ionomeric F-free or low-F copolymer materials described herein provide high conductivity (and thus low ASR) under hot and dry conditions (100 to 250° C.), which is important for heat management in large fuel cell stacks used in heavy-duty vehicles (HDVs). They can also conduct protons at low temperatures (<25° C.) and in the presence of humidified vapor. The U.S. Dept. of Energy's low-temperature PEM fuel cell (LT-PEMFC) 2025 Target for heat rejection normalized to temperature differential (Q/ΔT) is ≤1.45 kW ° C.⁻¹ at 40° C. ambient. LT-PEMFCs need to operate ≥90° C. to satisfy this requirement at the optimal cell power density (~0.75 W cm⁻²). Most LT-PEM fuel cells do not operate at this high temperature due to cell component durability concerns, and PFSA PEMs start to thermally degrade above 100° C. and suffer from poor proton conductivity due to dehydration. Hence, the current PFSA PEMs are limited in their ability to reach operating conditions satisfying the heat rejection requirement. Increasing the fuel cell stack operating temperature to 160° C. using the HT-PEM and electrode binders described herein, yields a Q/AT of 1.03 kW ° C.⁻¹, which easily satisfies the said DOE target. It is worth noting that the Q/AT requirement becomes more stringent when moving to larger stack systems that are required for HDV applications. For example, a light-duty vehicle (LDV) may use an 80 to 110 kW fuel cell stack. The stack(s) for HDVs in long-haul trucking may have a total power of 200 to 400 kW. Plus, fuel cell stacks for HDVs tend to run at 75% of the rated power and for much longer periods of time when compared to LDVs. Operating the stack at higher rated power leads to challenging heat management, which can be alleviated with a larger temperature differential.

The fluorine-free/low-fluorine HT-PEM ionomeric copolymers described herein can be fabricated into PEMs for fuel cells that do not require imbibed liquid acid in the membrane. The HT-PEMs described herein are copolymers featuring tethered phosphonic acid and sulfonic acid/sulfonimide and can operate under hot (130 to 220° C.), dry conditions. Eliminating the use of liquid imbibed acid in HT-PEM separators will resolve current challenges in phosphoric acid redistribution to electrode layers that result in electrode activity losses and an increase in ohmic resistances within the cell over time.

In some HT-PEM embodiments, the copolymer membranes (e.g., of Formulas (I)) are reinforced with a porous support structure (e.g., 50% porosity) to provide additional mechanical strength to the membranes. Non-limiting examples of such support structures include, e.g., hydrocarbon materials such as poly(phenylene sulfide) and other aromatic hydrocarbon supports (e.g., poly(arylene ether sulfone) that do not melt at temperatures up to 200° C.

In some embodiments, the polymers are poly(phenylene alkylene) copolymers of Formula (II):

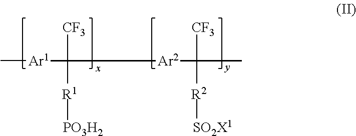

wherein Ar¹ and Ar² independently are bivalent aryl; R¹ and R² independently are hydrocarbyl (e.g., alkyl, aryl or other hydrocarbon groups); X¹ is selected from the group consisting of OH and NHSO₂Z¹; Z¹ is selected from the group consisting of hydrocarbyl (e.g., alkyl, aryl or another hydrocarbon moiety) and —PO₃H₂; and x and y are the number of repeats of the monomer units within the brackets. The hydrocarbyl groups in Formula (II) can include substitutions and/or substituents as discussed above with regard to Formula (I). Non-limiting examples of copolymers of Formula (II) include polymers in which Ar¹ and Ar² are biphenyl groups, ortho-terphenyl groups, meta-terphenyl groups, para-terphenyl groups, naphthyl groups, and the like, which can be bound to the C(CF₃)(R¹PO₃H₂) and C(CF₃)(R²SO₂X¹) groups through any two positions on the biphenyl groups, ortho-terphenyl groups, meta-terphenyl groups, para-terphenyl groups, or naphthyl groups. Optionally, the aryl groups can be substituted with alky groups.

Some typical examples of bivalent aryl groups A¹ and A² include biphenylene (A, below) and terphenylene groups such as meta-terphenylene (B, below).

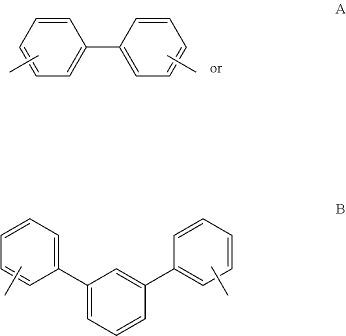

In some other embodiments, the polymers are poly(norbornene) copolymers, such as ring-opening polymerization poly(norbornene) (ROMP-PNB) copolymers of Formula (III), saturated ROMP-PNB copolymers (i.e., ROMP-PNB copolymers in which the backbone vinyl groups have been reduced hydrogenated to form saturated hydrocarbons) of Formula (IV), vinyl addition poly(norbornene) (VA-PN) copolymers (i.e., poly(norbornene) polymers including bridged bicyclic norbornyl monomer units) of Formula (V), as well as polymers including both VA-PNB- and ROMP-PNB-type segments. In Formulas (III), (IV) and (V), x, y, R¹ and R² are as defined in Formula (I); and z≥0 and represents the number of repeats of unsubstituted monomer units. In Formulas (III), (IV), and (V), X¹ is selected from the group consisting of OH and NHSO₂Z¹; and Z¹ is selected from the group consisting of a third hydrocarbyl group and —PO₃H₂.

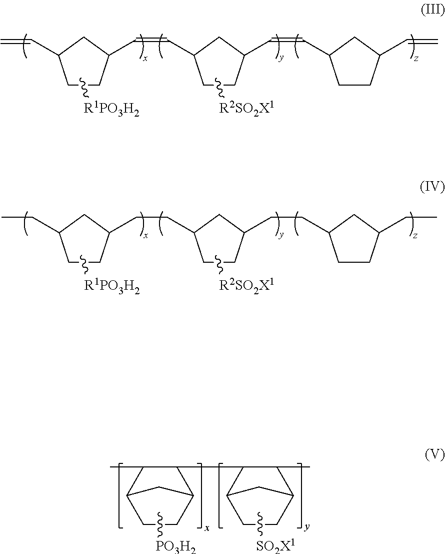

In yet other embodiments, the polymers are polymers of intrinsic porosity (PIM), such as the derivatives of PIM-1 shown below in Formula (VI), which include pendant phosphonic acid groups and pendant sulfonic acid/sulfonimide groups:

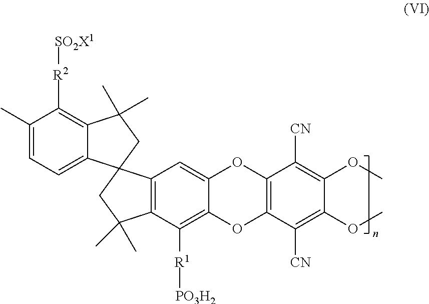

wherein R¹ and R² independently are covalent bonds or comprise hydrocarbyl (e.g., alkyl, aryl or other hydrocarbon groups); X¹ is selected from the group consisting of OH and NHSO₂Z¹; Z¹ is selected from the group consisting of hydrocarbyl (e.g., alkyl, aryl or another hydrocarbon moiety) and —PO₃H₂; and n>0 and represents the number of repeats of the monomer unit within the brackets. The hydrocarbyl groups in Formula (VI) can include substitutions and/or substituents as discussed above with regard to Formula (I). Non-limiting examples of copolymers of Formula (VI) include polymers in which R¹ and R² are alkylene groups such as —(CH₂)ₙ— wherein n is 1 to 6 (e.g., —CH₂—).

The ratio of x:y in Formula (I), (II), (III), (IV), (V), and (VI) can vary from about 0.11:1.0 to about 1.0:0.11. Typically, the ratio of x:y in Formula (I) is about 0.5:0.5 to about 0.6:0.4, and will be selected based on the proton transfer properties of the polymer when used as an HT-PEM or as a fuel cell electrode binder. The proportion of unsubstituted hydrocarbon monomer units (e.g., z in Formulas (III) and (IV)) in the polymers can also be varied to fine tune the polymer properties. The ratio of x:y is selected to provide the required proton exchange properties for the HT-PEM or binder, as the case may be, for the particular application in which the polymers are used. In the case of polymers with an additional monomer, such as in Formula (III) and (IV), the number of additional monomer units, e.g., z in Formulas (II) and (IV), is typically less than the combined values of x and y.

### Example 1. Preparation of Poly(Phenylene Alkylene) Polymers and Membranes

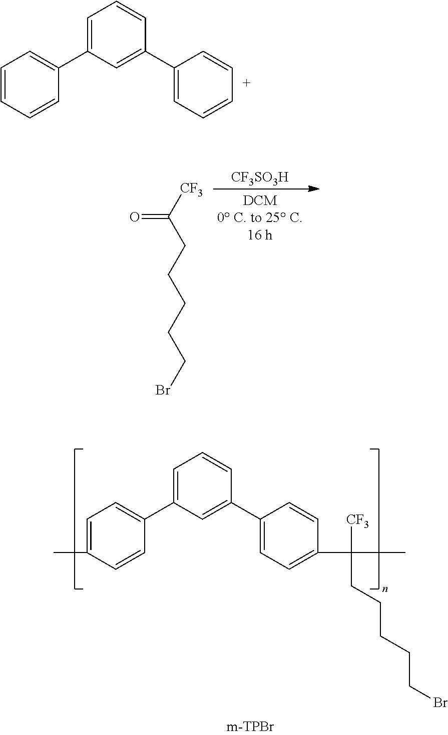

Preparation of m-TPBr

Note: This is for a reaction in 250 mL size round bottom flask. The reaction could be scaled by 2× when using a 500 mL round bottom flask.
1. For this reaction, use a three-necked 250 mL size round bottom flask equipped with a nitrogen inlet, magnetic stirrer, and additional funnel.
   Note: While a magnetic stirrer can be sufficient for small-scale reactions (1-2 grams), an overhead stirrer is preferable for larger-scale reactions as it provides better mixing of monomers.
2. To this flask, add 7-bromo-1,1,1-trifluorohexane-2-one (11.80 g, 47.75 mmol) and m-terphenyl (10 g, 43.42 mmol).
3. Purge the solution with nitrogen gas (for degassing) for 30 minutes. Add 60 mL of anhydrous DCM.
4. Cool the reaction flask to 0° C. using an ice bath. Add trifluoromethanesulfonic acid (TFSA, CF₃SO₃H) (31 mL, 347 mmol) dropwise using an addition/dropping funnel.
5. After the addition of TFSA, remove the ice bath and stir the reaction mixture at room temperature for 16 hours. The color of the reaction solution during this period will change to viscous dark brown.
6. After 16 hours, pour the viscous solution into methanol (MeOH, 600 mL). Wash the precipitated polymer with MeOH at least 3 times. Dry the polymer in a fume hood for 24 hours.
7. Re-dissolve the dried polymer in 200 mL of tetrahydrofuran (THF). Precipitate the polymer by pouring the polymer in THF into MeOH (1000 mL). Filter the precipitated polymer out. Dry the polymer in the fume hood initially for at least 4 hours followed by drying in a vacuum oven overnight.
8. Characterize the chemical structure of the dried polymer (m-TPBr) by ¹H NMR spectroscopy. Use deuterated chloroform (CDCl₃) as the solvent. Perform gel permeation chromatography (GPC) using THF as the solvent for determining the polymer's molecular weight.

### Preparation of BPBr

Note: This is for a reaction in 250 mL size round bottom flask. The reaction could be scaled by ½ or ¼ when using a smaller round bottom flask.

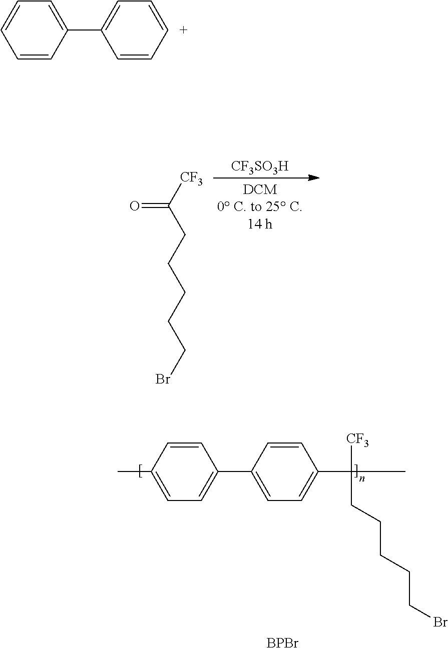

1. For this reaction, use a three-necked 250 mL size round bottom flask equipped with a nitrogen inlet, magnetic stirrer (or overhead stirrer), and additional funnel.
2. Add 7-bromo-1,1,1-trifluorohexane-2-one (17.62 g, 71.33 mmol, 1.1 eq.) and biphenyl (10 g, 64.85 mmol) into the flask.
3. Purge the solution with nitrogen gas (for degassing) for 30 minutes. Add 70 mL of anhydrous dichloromethane (DCM).
4. Cool the reaction flask to 0° C. using an ice bath. After that, add TFSA (35 mL, 389 mmol) dropwise using an addition/dropping funnel.
5. After the addition of TFSA, remove the ice bath and stir the reaction mixture at room temperature for 14 hours under nitrogen.
6. After 14-16 hours, pour the viscous solution into MeOH (600 mL) as the fibrous shape. After filtration, wash the precipitated polymer with MeOH at least 3 times. Dry the polymer in a fume hood only for 24 hours (as there will be residual acid present).
7. Re-dissolve the dried polymer in 300 mL of tetrahydrofuran (THF). Precipitate the polymer by pouring the polymer in THF into MeOH (1500 mL). Filter the precipitated polymer out. Dry the polymer in vacuum oven overnight (50-60° C.).
8. Characterize the chemical structure of the dried polymer (BPBr) by ¹H NMR spectroscopy. Use deuterated chloroform (CDCl₃) as the solvent. Perform GPC using THF as the solvent for determining the polymer's molecular weight.

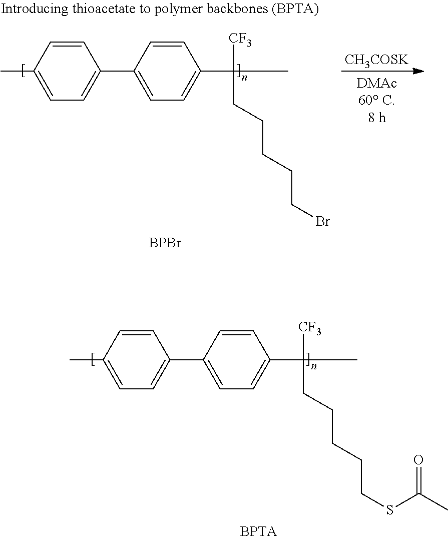 [SMILES: Cc1ccc(-c2ccc(C(C)(CCCCCBr)C(F)(F)F)cc2)cc1 ; "CH3COSK" ; "BPBr" ; CC(=O)SCCCCCC(C)(c1ccc(-c2ccc(C)cc2)cc1)C(F)(F)F ; "BPTA"]

1. For this reaction, use a two-necked 100 mL size round bottom flask equipped with a nitrogen inlet and magnetic stirrer, and additional funnel.
2. Add BPBr (4 g, 14.12 mmol) (or m-TPBr), potassium thioacetate (CH₃COSK) (3.22 g, 28.24 mmol), and DMAc (40 mL) into the flask.
3. Heat reaction solution to 60° C. by an oil bath for 8 hours.

After 8 hours, this reaction mixture can be used directly for the next homogenous oxidation reaction.
4. Cool the reaction mixture to room temperature. After that, precipitate the polymer from the reaction mixture by adding the solution dropwise into 200 mL of MeOH and stirred this solution for 30 minutes.
5. Filter the polymer from the solution and collect the filtered polymer. Dry the polymer in the fume hood only since thioacetate smells bad.
6. Re-dissolve the dried polymer in 40 mL of tetrahydrofuran (THF). Precipitate the polymer by pouring the polymer in THF into MeOH (e.g., 400 mL). Filter the precipitated polymer out.
7. Dry the polymer in the fume hood initially for at least 4 hours and then in a vacuum oven at 50° C. overnight.
8. Characterize the chemical structure of the dried polymer (BPTA) by 1H NMR spectroscopy. Use deuterated chloroform (CDCl₃) as the solvent.

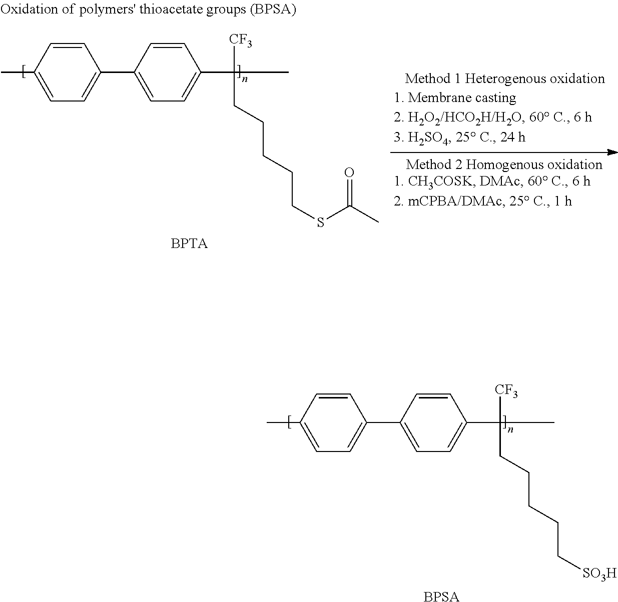

There are two methods to oxidize thioacetate groups to sulfonic acids on the polymer backbones (BPTA to BPSA), including heterogenous and homogenous oxidation. After oxidation, BPSA polymer is not soluble in any solvent.

### Prepare BPSA Membrane Casting for Heterogenous Oxidation (Method 1)

1. Dissolve BPTA by DMAc at a 5% wt./v concentration.
2. Pass the solution through a short plug of cotton to remove any insoluble dust particles.
3. Pour the freshly filtered solutions onto a clean glass plate.
4. Heat the samples up to 60° C. for 16 hours and 120° C. for 2 hours.
5. Immerse sample into deionized water to remove the membranes from the glass plates.
6. Dry the BPTA membrane.
7. Place the BPTA membrane into a solution of 30% hydrogen peroxide (H₂O₂), formic acid (HCO₂H), and water (H₂O) in a 1:1:4 ratio by volume (10:10:40 mL).
8. Heated to 60° C. for 6 hours.
9. Rinse the membranes thoroughly with water.
10. Immerse the membranes into 1 M sulfuric acid (H₂SO₄) for 24 hours.
11. Then, rinse the membranes with deionized water until the rinse solution became neutral.
12. The membranes were then placed into fresh deionized water for 24 hours, replacing with fresh water three times over the course of 24 hours.

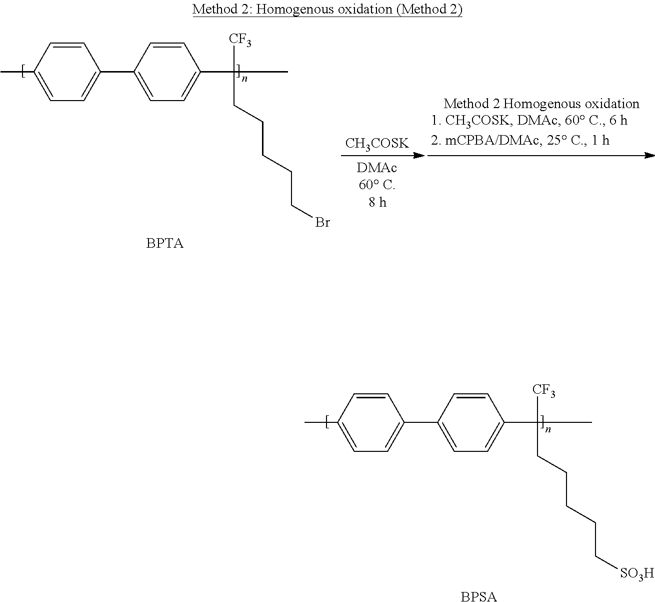

Follow the first 3 synthetic procedures in step 2 (introducing thioacetate to polymer backbones (BPTA))

After stirring the reaction for 8 hours, the reaction mixture is used directly to the next step for homogenous oxidation instead of working up.
1. Dissolve meta-chloroperoxybenzoic acid (mCPBA) (2.7 g, 15.6 mmol) in 5 mL DMAc and add this mCPBA solution dropwise over 30 minutes by dropping funnel to the flask.
2. Stir reaction mixture at room temperature for 1 hour.
3. Precipitate the oxidized polymer from the reaction mixture by adding the solution dropwise into 400 mL 1M sodium chloride (NaCl) and stir this suspension for 30 minutes.
4. Filter the polymer from the solution, collect the filtered polymer, and dry the polymer.
5. Re-dissolve the dried polymer in 40 mL of dimethylsufloxide (DMSO). Precipitate the polymer by pouring the polymer in DMSO into acetone (200 mL). Filter the precipitated polymer out. Dry the polymer in a vacuum oven overnight.

### Phosphonation

Starting with BPBr, which has biphenyl groups in the polymer backbones, a Michaelis-Arbuzov reaction is performed to convert organohalide on the polymers side chain, followed by hydrolysis to yield the target phosphonic acid (P(═O)OH₂) function group on the polymer's side chain. The same strategy is applied to m-TPBr polymer. The following scheme is the general synthetic routes for biphenyl or m-terphenyl polymer structures in each step.

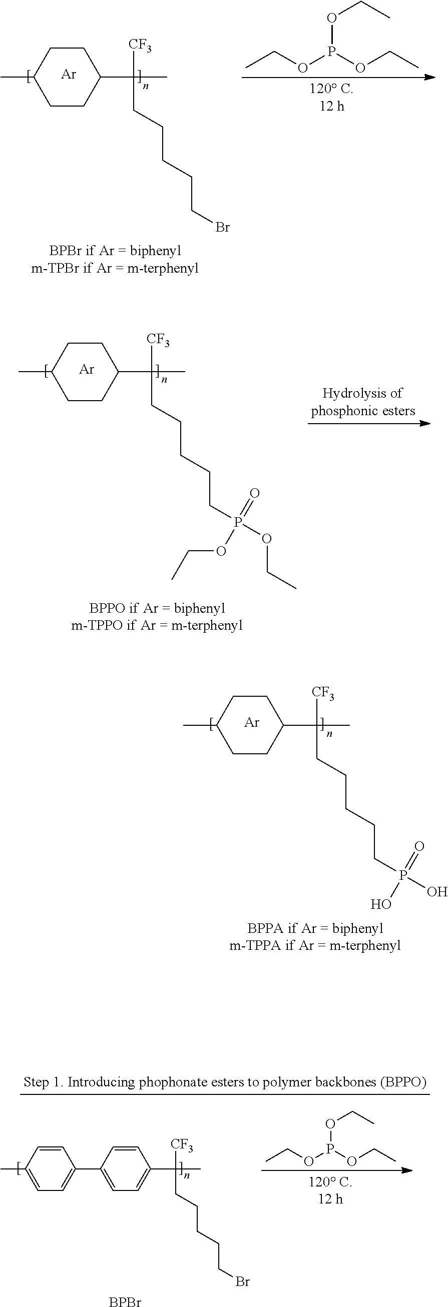

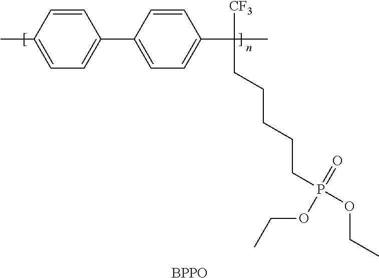 [SMILES: CCOP(=O)(CCCCCC(C)(c1ccc(-c2ccc(C)cc2)cc1)C(F)(F)F)OCC ; "BPPO"]

1. For this reaction, place BPBr (which is the product of CEM polymers in the first step 1) and magnetic stirrer in a two-necked 100 mL size round bottom flask equipped with a nitrogen inlet and dropping funnel.
2. Add triethyl phosphite (TEP, 1.5 equivalents (equiv.)) slowly into flask by additional funnel.

Triethyl phosphite can be added neat, without solvent, or with dichloromethane (DCM) or with N,N-dimethylacetamide (DMAc).
3. Heat up the solution to 120° C. in an oil bath for 12 hours.
   Note: If the reaction/conversion is not completed, longer reaction time can be used or the reaction vessel can be sealed.
4. Observe the properties of raw products to determine appropriate purifications. Study the solubility of this product and attempt to perform recrystallization or reprecipitation to purify this product.
5. Precipitate the polymers in one or more solvents such as water.

Dry the polymer (BPPO) for the next step.

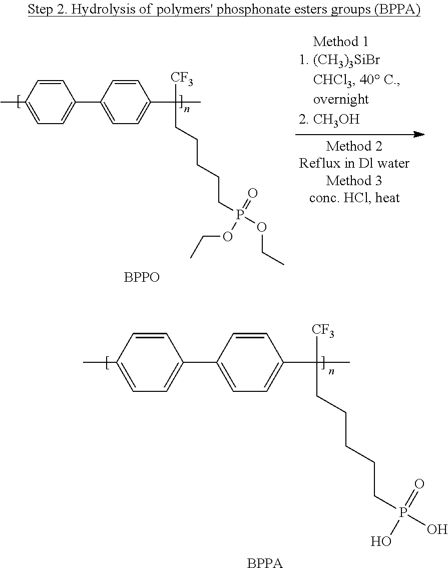

There are at least three methods to hydrolysis phosphonate esters groups to phosphonic acid on the polymer backbones (BPPO to BPPA), including treating with trimethylsilane bromide ((CH₃)₃SiBr or TMSBr), hot water (H₂O), and acid.

### Method 1: Trimethylsilane Bromide (TMSBr) Hydrolysis

1. For this reaction, place BPPO polymers and magnetic stirrer in a two-necked 100 mL size round bottom flask.
2. Cool the reaction flask to 0° C. using an ice bath.
3. Add a suitable solvent for the polymer, such as DCM or CHCl₃.
4. Add TMSBr (about 6-7 equiv.) to the flask.
5. Heat up this solution to 40° C. for overnight (~12 hours).
6. Add MeOH (MeOH) to reaction mixture.²

For some polymers, adding hydrochloric acid (HCl) can be helpful to induce precipitation.
7. Stir suspension mixture (upon to 24 hours)
8. Filter this solution and wash polymer product with deionized water several times, and dried under vacuum at 60° C. The success of hydrolysis was confirmed by titration.

### Method 2. Hot Water (H₂O) Hydrolysis

1. For this reaction, add polymers, H₂O, and stirred bar in the 100 mL single round bottom flask.
2. Heat up the solution to reflux in an oil bath for 24 hours.
3. After that, cool the polymer dispersion.
4. Filter precipitated polymer and rinse the product with boiling water thrice for half an hour each time.
5. Treat polymer within 2 wt % phosphoric acid (H₃PO₄) to convert the phosphonate ester into phosphonic acid form.
6. Filter this solution and wash the frit several times until the filtrate was pH 6 to 7.
7. Dry the collected polymer (BPPA) under a vacuum at 60° C.

### Method 3: Acid Hydrolysis

1. For this reaction, add polymers, HCl, and stirred bar in the 100 mL single round bottom flask.
2. Heat up the solution to 90° C. in an oil bath for 24 hours.
3. After that, cool the polymer dispersion and gradually pour into an excess volume of DI water.
4. Filter this solution and wash the frit several times until the filtrate was pH 6 to 7.
5. Dry the collected polymer (BPPA) under a vacuum at 60° C.

The above examples illustrate introduction of either sulfonic acid or phosphonic acid groups onto the poly(phenylene alkylene) polymer backbone via an alkyl tethering group. The same approaches are applied to introduce both sulfonic acid and phosphonic acid groups into the same polymer backbone, e.g., by only converting a portion of the bromo groups to sulfonic acids and then converting the remaining bromo groups to phosphonic acids, or vice versa.

The above procedure also can be applied to a terphenylene material, in addition to the biphenylene example give above, be replacing the biphenylene reagents with corresponding reagents.

### Example 2. Preparation of Poly(Norbornene) Polymers

### Preparation of Bromobutyl Norbornene

A mixture of dicyclopentadiene (3.97 g, 30 mmol) and 6-bromo-1-hexene (19.57 g, 120 mmol) was prepared in a 350 mL pressure vessel equipped with a magnetic stir bar. The vessel was sealed, and the reaction mixture was heated at 190° C. for 72 hours. After cooling down the reaction mixture, the mixture was distilled under reduced pressure (1-3 torr) at elevated temperature (unreacted 6-bromo-1-hexene was distilled at 75° C., and the product was distilled at 140° C.) to obtain a transparent oily liquid. The solvent was further purified by column chromatography on silica gel with hexanes as eluent. Hexanes were removed under a vacuum to get the product.

### Preparation of ROMP-PBBNB

ROMP-based bromine-containing homopolymer (m-PBBNB) was synthesized from BBNB monomers. In a 40 ml vial equipped with a stirring bar, Grubbs 3^{rd} generation catalyst solution (1 mM) was prepared by dissolving the Grubbs 3^{rd} catalysts (0.012 g) in 16 ml of chloroform inside a glove box. In a 4 ml vial, the monomer solution (2 M) was prepared by dissolving the bromobutyl norbornene monomer (1 g) in 2.19 ml of chloroform inside a glove box. Both monomer and catalyst vials were taken out from the glove box. The catalyst vial was placed on the −27~−30° C. cooling bath (mixture of o-xylene, small amount of acetonitrile, and liquid nitrogen in dewar) and stirred for 5 mins. After that, the monomer vial was opened, and the solution was withdrawn with a 3 ml syringe and injected into the catalyst vial. During the reaction, the cooling bath temperature was monitored by a thermometer, and liquid nitrogen kept added to the dewar to maintain the temperature range (about −27 to about −30° C.). The ROMP reaction was terminated by adding ethyl vinyl ether after 6 h. The reaction mixture was further stirred for 30 mins in the opened vial and then precipitated in 40 ml of methanol with vigorous stirring. After vacuum filtration, the filtrate was dried in a vacuum overnight.

### Hydrogenation of ROMP-PBBNB

The unsaturated ROMP-PBBNB and tosyl hydrazide (1:6 ratio of the double bond to hydrazide) were dissolved in chlorobenzene at room temperature. The solution was purged with nitrogen gas for 30 min. The mixture was stirred at 135° C. for 6 hrs under nitrogen gas. The solution was then cooled to room temperature and then precipitated in methanol with vigorous stirring for three times. After precipitation, the polymer was dried in a vacuum overnight.

### Preparation of Sulfonated Hydrogenated ROMP-PBBNB (H-ROMP-PBBNB) Membrane Through Heterogeneous Oxidation.

The hydrogenated ROMP-PBBNB and potassium thioacetate were dissolved in mixture of THF and DMSO. The solution was heated to 60° C. for 6 hours. After cooling down the reaction mixture, we poured onto a clean and leveled glass plate and heated at 60° C. for 16 h. The membrane was removed from the glass plates by immersing in deionized water and then dried. The thioacetate functionalized H-ROMP-PBBNB membrane was placed into a solution of 30% hydrogen peroxide, formic acid, and water in a 1:1:4 ratio by volume and heated to 60° C. for 6 h. The membrane was rinsed with water, then placed into 1 M sulfonic acid for 24 h. The membrane was rinsed with water for three times and stored in water.

### Example 3. Preparation of Bromo-Substituted Polymer Intermediates

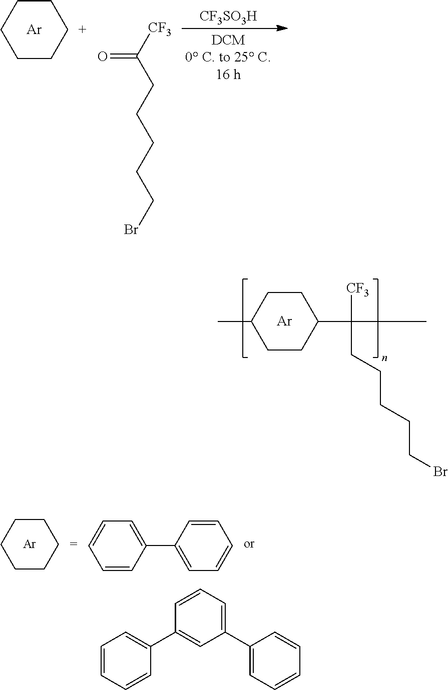

The aromatic hydrocarbon m-terphenyl (mTP, 10.0 g, 43.42 mmol) or biphenyl (BP, 10.0 g, 64.85 mmol) was copolymerized with 7-Bromo-1,1,1-trifluorohexane-2-one (11.80 g, 47.75 mmol) in 60 mL of dichloromethane (DCM) by superacid catalized polymerization. After trifluoromethanesulfonic acid (triflic acid, TfOH; CF₃SO₃H; 31 mL, 347 mmol) was added dropwise via the addition funnel at 0° C., the reaction mixture was warmed up and stirred for 7-9 hours at about 25° C. to form a bromo-substituted copolymer intermediate. Starting with BP, brominated polymer BPBr was formed after about 9 hours reaction time, and had a weight average molecular weight (M_{w}) of about 49 kDa and a polydispersity index (PDI; ratio of M_{w} to number average molecular weight (Mₙ)) of about 1.8. The corresponding polymer formed from mTP had a weight average molecular weight of about 22 kDa, and a PDI of about 1.2 after approximately 7 hours reaction time. Molecular weights were determined by gel permeation chromatography (GPC) in tetrahydrofuran (THF) with polystyrene standards.

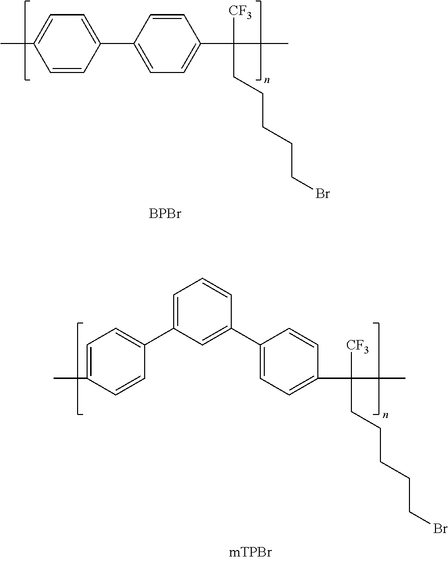

### Example 4. Preparation of BPTA

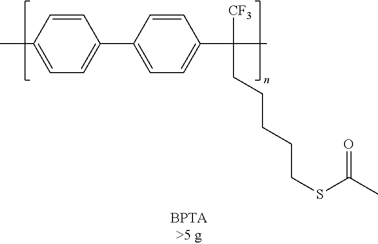

BPBr from Example 3 was reacted with potassium thioacetate (KSAc) to displace the bromo substituent forming the thioacetate BPTA. In particular, BPBr (4.0 g) was reacted with KSAc (3.22 g) in dimethylacetamide (DMAc; 40 mL) at about 60° C. for about 24 hours to form BPTA. BPTA was then oxidized to the sulfonate, BPSA, by heterogeneous oxidation of BPTA membranes or using m-chloroperbenzoic acid (mCPBA) homogeneous oxidation. The sulfonation was confirmed by proton NMR.

### Example 5. Preparation of BPPA (49 kDa)

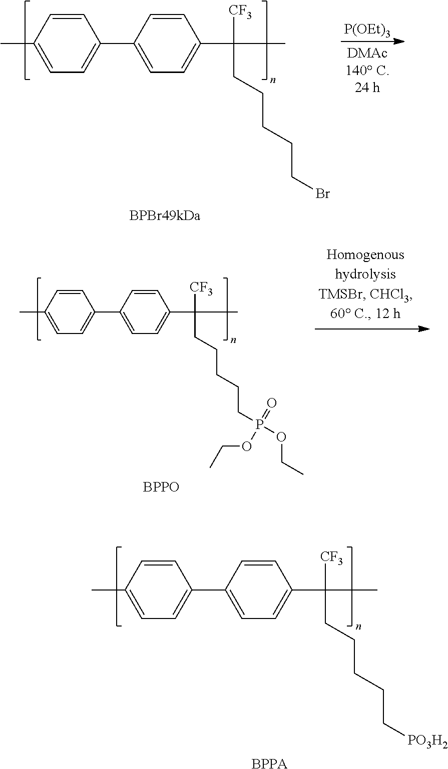

BPBr from Example 3 was converted to the phosphonate BPPA as follows:

BPBr (M_{w} 49 kDa, DPI=1.8; GPC, THF, polystyrene standards; 1.5 g) was combined with triethyl phosphite (15 mL) and dimethylacetamide (DMAc; 4 mL) in a 100 mL one-neck round-bottom flask. The reaction mixture was heated at 140° C. for 24 h. After cooling, the polymer was precipitated into diethyl ether, and the solid was rinsed multiple times with ether. The product (BPPO) was dried overnight. Successful substitution of the bromomethyl groups with triethyl phosphite (P(OEt)₃) was confirmed by ¹H and ³¹P NMR spectroscopy, as indicated by a diagnostic chemical shift change of the —CH₂—Br resonance (peak 7), the appearance of new ethyl resonances in the ¹H NMR spectrum (peaks 8 and 9), and the emergence of new singlet phosphorus resonances in the ³¹P NMR spectrum.

BPPA synthesis: BPPO (0.50 g) was placed in a 100 mL two-neck round-bottom flask with chloroform (CHCl₃, 10 mL) and stirred. Excess bromotrimethylsilane (TMSBr, 5 mL) was added by syringe and the mixture was heated at 50° C. under nitrogen for 12 h. Methanol was then added and the mixture was heated to 80° C. and stirred for 4 h. The supernatant was removed and the solids were rinsed with methanol several times. The product (BPPA) was dried overnight. Successful hydrolysis of the phosphite (diethyl phosphonate) groups was confirmed by ¹H and ³¹P NMR spectroscopy, as indicated by the disappearance of the ethyl resonances in the ¹H NMR spectrum and a corresponding chemical shift change of the phosphorus resonances in the ³¹P NMR spectrum.

### Example 6. Preparation of mTPPA (22 kDa)

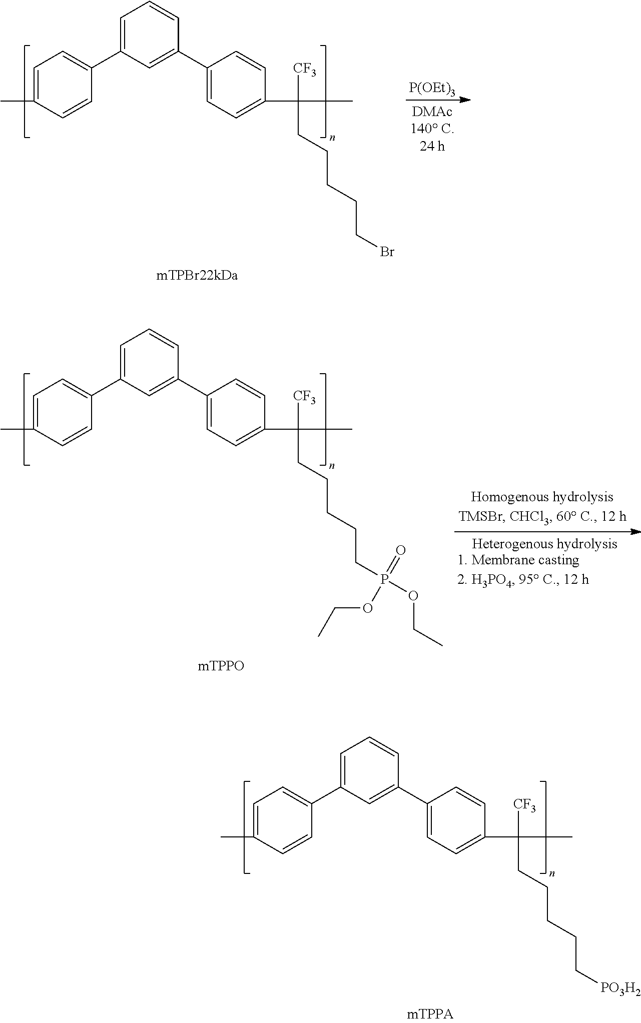

BPBr from Example 3 was converted to the phosphonate mTPPA as follows:

mTPBr (M_{w}=22 kDa, PDI=1.2; GPC, THF, polystyrene standards; 1.0 g) was combined with triethyl phosphite (10 mL) and DMAc (2 mL) in a 100 mL one-neck round-bottom flask. The reaction mixture was heated at 140° C. for 24 h. After cooling, the polymer was precipitated into diethyl ether and rinsed multiple times with ether. The product (mTPPO) was dried overnight. Successful substitution of the bromomethyl groups with triethyl phosphite (P(OEt)₃) was confirmed by ¹H and ³¹P NMR spectroscopy, as indicated by a diagnostic chemical shift change of the —CH₂—Br resonance (peak 7), the appearance of new ethyl resonances in the ¹H NMR spectrum (peaks 8 and 9), and the emergence of new phosphorus resonances in the ³¹P NMR spectrum.

mTPPO (0.50 g) was placed in a 100 mL two-neck round-bottom flask with CHCl₃ (10 mL) and stirred. Excess TMSBr (5 mL) was added by syringe, and the mixture was heated at 50° C. under nitrogen for 12 h. Methanol was then added and the mixture was heated to 80° C. and stirred for 4 h. The supernatant was removed and the solids were rinsed with methanol several times. The product (mTPPA) was dried overnight. Successful hydrolysis of the phosphite (diethyl phosphonate) groups was confirmed by ¹H and ³¹P NMR spectroscopy, as indicated by the disappearance of the ethyl resonances in the ¹H NMR spectrum and a corresponding chemical shift change of the phosphorus resonances in the ³¹P NMR spectrum.]

### Example 7. Membrane Preparation and Characterization

[Stock solutions of BPTA (derived from BPBr, M_{w}=49 kDa; 10 wt % in DMAc) and mTPPA (derived from mTPBr, M_{w}=22 kDa; 5 wt % in DMAc) were prepared. These stock solutions were combined to afford a BPTA:mTPPA=7:3 blend composition (weight basis) and used to prepare membranes by drop-casting. No macroscopic phase separation was observed in the cast films. The resulting membranes were subjected to heterogeneous oxidation following the same procedure described for BPSA membrane preparation.

In-plane ionic conductivity of the water-soaked films was measured by electrochemical impedance spectroscopy (EIS) using a Scribner in-plane conductivity cell. The oxidized BPTA:mTPPA (7:3) films exhibited an in-plane conductivity of 33±8 mS/cm at 23.7° C. and 56 mS/cm at 80° C. For comparison, oxidized BPTA films exhibited an in-plane conductivity of 84±5 mS/cm at 23.7° C. and 161 mS/cm at 80° C.]

Any references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. A polymer of Formula (I): 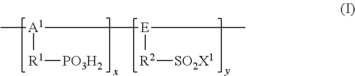
wherein
A-R¹—PO₃H₂ is a first repeating monomer unit;
E-R²—SO₂X¹ is a second repeating monomer unit;
A and E each independently comprises a first hydrocarbyl group;
R¹ and R² each independently is a covalent bond or comprises a second hydrocarbyl group;
X¹ is selected from the group consisting of OH and NHSO₂Z¹;
Z¹ is selected from the group consisting of a third hydrocarbyl group and —PO₃H₂;
x and y are the number of repeats of the first and second monomer units, respectively; and
both x and y are greater than 0;
wherein one or more of the first, second, and third hydrocarbyl groups optionally comprises (a) one or more halogen, oxygen-, nitrogen-, and/or sulfur-containing substituent; (b) one or more substitution of oxygen, nitrogen, and/or sulfur replacing a carbon of the hydrocarbyl group; or (c) both (a) and (b); and the polymer is fluorine-free or comprises no more than three fluorine substituents per monomer unit.

2. The polymer of claim 1, wherein the first hydrocarbyl group comprises a moiety selected from the group consisting of linear alkyl, branched alkyl, cycloalkyl, linear alkenyl, branched alkenyl, cycloalkenyl, aryl, and a combination of two or more of the foregoing.

3. The polymer of claim 1, wherein the second hydrocarbyl group comprises a moiety selected from the group consisting of linear alkyl, branched alkyl, cycloalkyl, linear alkenyl, branched alkenyl, cycloalkenyl, aryl, and a combination of two or more of the foregoing and/or the third hydrocarbyl group comprises a moiety selected from the group consisting of alkyl, aryl, and a combination thereof.

4. The polymer of claim 1, wherein X¹ is OH.

5. The polymer of claim 1, wherein X¹ is NHSO₂Z.

6. The polymer of claim 5, wherein Z¹ is the third hydrocarbyl group.

7. The polymer of claim 6, wherein the third hydrocarbyl group comprises a moiety selected from the group consisting of alkyl, aryl, and a combination thereof.

8. The polymer of claim 5, wherein Z¹ is —PO₃H₂.

9. The polymer of claim 1, wherein the sum of x+y is at least about 25, or the sum of x+y is about 25 to about 500.

10. The polymer of claim 1, wherein the ratio of x:y is at least about 0.1:1.0 to about 1.0:0.1.

11. The polymer of claim 1, wherein the polymer is soluble in an organic solvent having a boiling point of less than about 170° C.

12. The polymer of claim 11, wherein the solvent is a C₁ to C₆ alcohol.

13. A polymer electrolyte membrane comprising the polymer of claim 1 in the form of a free-standing membrane having a thickness of about 10 μm to about 100 μm, or on a porous support structure.

14. A polymer of Formula (I): 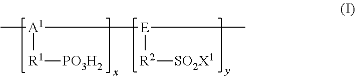
wherein A-R¹—PO₃H₂ is a first repeating monomer unit;
E-R²—SO₂X¹ is a second repeating monomer unit;
A and E each independently comprises a first hydrocarbyl group;
R¹ and R² each independently is a covalent bond or comprises a second hydrocarbyl group;
X¹ is selected from the group consisting of OH and NHSO₂Z¹;
Z¹ is selected from the group consisting of a third hydrocarbon group and —PO₃H₂;
x and y are the number of repeats of the first and second monomer units, respectively; and
both x and y are greater than 0;
wherein one or more of the first, second, and third hydrocarbyl groups optionally comprises (a) one or more halogen, oxygen-, nitrogen-, and/or sulfur-containing substituent; (b) one or more substitution of oxygen, nitrogen, and/or sulfur replacing a carbon of the hydrocarbyl group; or (c) both (a) and (b); the polymer is fluorine-free or comprises no more than three fluorine substituents per monomer unit; and wherein A and E together constitute a polymer backbone selected from the group consisting of a poly(arylene alkylene), a poly(norbornene), a polymer of intrinsic porosity, a cyclic polyolefin, a polyolefin, a polyimide, and a poly(arylene ether).

15. The polymer of claim 14, wherein the first hydrocarbyl group comprises a moiety selected from linear alkyl, branched alkyl, cycloalkyl, linear alkenyl, branched alkenyl, cycloalkenyl, aryl, and a combination of two or more of the foregoing.

16. The polymer of claim 14, wherein X is OH.

17. The polymer of claim 14, wherein X is NHSO₂Z¹.

18. The polymer of claim 17, wherein Z is the third hydrocarbyl group.

19. The polymer of claim 18, wherein the third hydrocarbyl group comprises a moiety selected from the group consisting of alkyl, aryl, and a combination thereof.

20. The polymer of claim 18, wherein Z¹ is —PO₃H₂.

21. The polymer of claim 14, wherein the sum of x+y is at least about 25; or the sum of x+y is about 25 to about 500.

22. The polymer of claim 14, wherein the ratio of x:y is at least about 0.1:1.0 to about 1.0:0.1.

23. The polymer of claim 14, wherein the polymer is soluble in an organic solvent having a boiling point of less than about 170° C.

24. The polymer of claim 23, wherein the solvent is a C₁ to C₆ alcohol.

25. A polymer electrolyte membrane comprising the polymer of claim 14 in the form of a free-standing membrane having a thickness of about 10 m to about 100 m, or on a porous support structure.
